(19) United States
(12) Patent Application Publication
(10) Pub. No.: US 2010/0265041 A1
(43) Pub. Date: Oct. 21, 2010

(54) RFID TRANSPONDER

(75) Inventors: Benyamin ALMOG, Beit Arie (IL); Tzahi Hachamo, Herzlia (IL); Zvi Nitzan, Zofit (IL); Doron Lavee, Carmei Yosef (IL); Paul Fenster, Petach-Tikva (IL)

Correspondence Address: MARTIN D. MOYNIHAN d/b/a PRTSI, INC., P.O. BOX 16446, ARLINGTON, VA, 22215, US

(73) Assignee: PowerID Ltd., Petach-Tikva (IL)

(21) Appl. No.: 12/426,309

(22) Filed: Apr. 20, 2009

Related U.S. Application Data
(63) Continuation-in-part of application No. 12/424,749, filed on Apr. 16, 2009.

(51) Int. Cl. H04Q 5/22; H01Q 21/00; H01Q 9/16

(52) U.S. Cl. 340/10.1; 343/810

(57) ABSTRACT

A radio frequency identification (RFID) transponder comprising:
an antenna comprising at least two connected dipoles, and having an input port feeding one of the dipoles;
a conductive ground plane separated by a predetermined distance from the antenna by a dielectric; and
a transponder electrically connected to the input port and operative to produce a response signal when the transponder receives a signal at a given frequency from the antenna.

### RELATED APPLICATION

This application is a continuation-in-part of U.S. patent application Ser. No. 12/424,749 filed on Apr. 16, 2009, the disclosure of which is incorporated herein by reference.

### FIELD AND BACKGROUND OF THE INVENTION

The present invention, in some embodiments thereof, relates to tracking of objects, and more particularly, but not exclusively, to transponders useful in some radio frequency identification applications.

Radio frequency identification (RFID) is a technology used to track objects, vehicles, people, and animals in a wide variety of situations. Since RFID uses radio waves, the items being tracked do not need to be in close proximity or line of sight, and can even be moving. Examples of the technology include inventory tracking in a retail store or warehouse, progress monitoring of manufactured goods in a production environment, and automated billing of vehicles traveling on toll roads.

In an RFID system each tracked item carries an attached transponder (also called a “tag”). A reader or interrogator device transmits a modulated radio frequency (RF) signal that is received by one or more of the tracked items. The transponder on each item demodulates and processes the signal and, if appropriate, sends a modulated RF signal in reply. The reader receives and demodulates the reply signal from the transponder, and usually passes the received information to an associated data processor or computer for further processing. While a variety of information can be communicated from the transponder to the reader, the most common transmitted information is a unique identification number that is stored in each transponder.

A transponder comprises an antenna, for receiving and transmitting the RF signals, and an electronic circuit, generally an application specific integrated circuit (“ASIC” or “ASIC chip”), to store the transponder's unique identification number and to perform RF modulation and demodulation. The transponder also optionally includes a power source or battery. The selected antenna should have a gain, form factor, and radiation pattern appropriate for the RFID application.

It is generally desirable for the transponder to be relatively inexpensive and unobtrusive. In one format the transponder is in the form of a label that can be affixed to the tracked object, or to a box or carton containing the objects. Some of the transponder components, such as the antenna and input port, can be imprinted on the label by a suitable deposition method known in the art. Other components such as the chip and battery have a low profile and can be attached to a surface of the label, or embedded in the label.

A fundamental principle of radio frequency design is that the impedance of adjacent components should match at the circuit operating frequency to maximize power transfer and efficiency. Accordingly, the antenna and ASIC chip in a transponder should be impedance matched since they are connected to each other. For optimum efficiency the resistance (real part of the impedance) values of the two components should match, and the reactance (imaginary part of the impedance) values should also match and be opposite in sign to cancel one another out.

A consequence of the above principle is that the impedances of the selected antenna and ASIC chip need to be considered when designing an RFID transponder. For example, a popular antenna used in RFID systems operating in the ultra high frequency (UHF) band is a dipole antenna, which comprises two quarter-wavelength conductors or elements placed back to back for a total length of a half-wavelength. However, a dipole antenna has a characteristic impedance of 73 ohms at resonance frequency, while a transponder ASIC chip operating in the UHF 850-960 MHz band typically has a relatively low resistance in the 5-20 ohm range and a relatively large reactance of about minus j200 ohms. Since this represents a relatively large difference in impedance values, it is necessary that the components be matched. This is usually achieved by inserting an additional component, called a matching element, between the antenna and ASIC chip.

Some RFID antennas incorporate matching features so that a separate matching element is not needed. One such design is described in a paper by Chen, “Performance of a Folded Dipole with a Closed Loop for RFID Applications” (Progress in Electromagnetics Research Symposium, 2007). As shown in FIG. 1 of the paper, the antenna has two open folded parts arranged back to back and a closed loop connected close to the feed point. The closed loop has the effect of driving down antenna impedance, particularly the real part. The length of the folded parts and closed loop can be independently set to obtain selected real and imaginary impedance values for the antenna that match corresponding values of a connected ASIC chip. A similar approach is shown in U.S. Pat. App. 2006/0208900 to Hozouri.

An RFID application of interest is tracking goods made of metal or other conductive materials, such as steel slabs and coils, metal containers, and automotive and aerospace components. However, there is a physical principle that antennas placed in close proximity to a relatively large conductive body such as metal characteristically experience a large drop in resistance and an increase in capacitance. This phenomenon becomes increasingly significant as the distance from the antenna to the conductive body is reduced to less than 5% of the wavelength. For example, at a frequency of 915 Mhz, wavelength is about 330 mm, and the above effect on impedance accordingly becomes acute within a distance of less than 16 mm. Since a typical RFID transponder label is less than 1 mm thick, the effect on the RFID antenna impedance when the label is attached to a metal object is very significant. For example, it is not uncommon for the antenna impedance to be driven to a value of approximately 1 −j500 ohms, which is substantially smaller than the desired value of about 10 +j200 ohms needed to match typical ASIC chip impedances in the UHF 850-960 MHz band. Accordingly, as a result of this phenomenon RFID tracking of metal objects using a general purpose RFID tag is problematic and ineffective.

One approach to this problem is to increase the thickness of the transponder label, so that the antenna is positioned far enough away from the metal object being tracked to reduce the effect on impedance. For example, in the case described above a 16 mm or thicker label should be effective. However, increasing transponder thickness to such an extent causes the transponder to conspicuously protrude from the object being tracked, where it generally interferes with the handling of the object and is prone to being damaged or dislodged.

Another approach is to use a patch antenna, which is a type of antenna that remains relatively unaffected by proximity to a conductive surface. A patch antenna consists of a metal patch suspended over a ground plane. RFID applications generally use a microstrip patch antenna, which is a patch antenna built on a dielectric substrate.

Patch antennas however have a number of practical disadvantages when used in RFID. The antennas are relatively large in size, as they are a half-wavelength long, cannot be folded, and usually have a ground plane larger than the patch. Furthermore, patch antennas have a rigid structure, are costly due to the dielectric, and are difficult to impedance match to ASIC chips.

### SUMMARY OF THE INVENTION

According to an aspect of some embodiments of the present invention there is provided an improved radio frequency identification (RFID) transponder for tracking conductive objects.

There is thus provided, in accordance with an embodiment of the invention a radio frequency identification (RFID) transponder comprising:

an antenna comprising at least two connected dipoles, and having an input port directly feeding one of the dipoles;

a conductive ground plane separated by a predetermined distance from the antenna by a dielectric; and

a transponder electrically connected to the input port and operative to produce a response signal when the transponder receives a signal at a given frequency from the antenna.

Optionally, the at least two dipoles comprise at least three dipoles.

Optionally, at the given frequency, the real part of the input impedance of the antenna in free space in the absence of the conductive ground plane is at least 100 or 200 ohms.

Optionally, at the given frequency, the imaginary part of the input impedance of the antenna in free space in the absence of the conductive ground plane is greater than +j100 ohms.

There is further provided, in accordance with an embodiment of the invention, a radio frequency identification (RFID) transponder comprising:

an antenna comprising at least three connected dipoles, and having an input port directly feeding one of the dipoles, and a transponder electrically connected to the input port and operative to produce a response signal when the transponder receives a signal at a given frequency from the antenna.

Optionally, at the given frequency the real part of the input impedance of the antenna in free space is at least 100 or 200 ohms.

Optionally, at the given frequency the imaginary part of the input impedance of the antenna in free space is greater than +j100 ohms.

In some embodiments of the invention, the dipoles are parallel. Optionally, the structure formed by the dipoles is rectangular.

Optionally, the antenna is sized and shaped to form an impedance match with the transponder with a reflection coefficient of less than or equal to 0.25 at the given frequency.

In some embodiments of the invention, the antenna is mounted on a dielectric structure having a given thickness, less than five, two or one percent of the free space wavelength at the given frequency.

Optionally, each of the dipoles has a same length, a same width, and a same separation distance from an adjacent dipole. Alternatively, one of the dipoles has at least one of a length, a width, and a separation distance from an adjacent dipole that is different from the corresponding length, width, or separation distance of at least one other dipole.

In an embodiment of the invention, a major portion of the dielectric is formed from a dielectric material having a first dielectric constant and a thickness in the range of 1 to 3 mm.

Optionally, the dielectric is formed of two layers and a thinner dielectric layer has a second dielectric constant higher than the first dielectric constant and a thickness in the range of 0.025 to 0.10 mm.

There is further provided, according to an embodiment of the invention, a method comprising attaching a transponder according to the invention to a conductive surface

There further provided, according to an embodiment of the invention, an antenna comprising:

a conductive ground plane,

at least two connected dipoles forming a structure substantially parallel to the conductive ground plane, and

an input port directly feeding one of the dipoles.

Optionally, at a given frequency the real part of the input impedance of the antenna in free space in the absence of the conductive ground plane is at least 100 or 200 ohms. Optionally, at the given frequency the imaginary part of the input impedance of the antenna in free space in the absence of the conductive ground plane is greater than +j100 ohms.

In an embodiment of the invention, the at least two dipoles are separated from the conductive ground plane by a dielectric material of a given thickness. Optionally, the given thickness is in the range of 1 to 3 mm.

Optionally the structure formed by the dipoles is rectangular.

There is further provided, in accordance with an embodiment of the invention, an antenna comprising:

at least three connected dipoles, and

an input port that feeds the dipoles.

Unless otherwise defined, all technical and/or scientific terms used herein have the same meaning as commonly understood by one of ordinary skill in the art to which the invention pertains. In case of conflict, the patent specification, including definitions, will control. Although methods and materials similar or equivalent to those described herein can be used in the practice or testing of embodiments of the invention, exemplary methods and/or materials are described below. The materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. In the drawings:

FIG. 1 is a perspective view of an RFID system showing two embodiments of an RFID transponder mounted on objects, in accordance with an embodiment of the invention;

FIG. 2A is a schematic view of a multi folded dipole having five folds, in accordance with an embodiment of the invention;

FIG. 2B is a schematic exploded view of the multi folded dipole of FIG. 2A, showing folded ends on each of the dipoles;

FIG. 3A is a schematic view of a multi folded dipole having three folds, with one dipole having a shorter length than the other two dipoles, in accordance with an embodiment of the invention;

FIG. 3B is a schematic view of a multi folded dipole having four folds, with one dipole having a wider width than the other three dipoles, in accordance with an embodiment of the invention;

FIG. 3C is a schematic view of a multi folded dipole having six folds, with the spacing between two adjacent dipoles being narrower than the spacing between the other dipoles, in accordance with an embodiment of the invention;

FIG. 4 is a graph of radiation resistance of a quarter wave antenna, as a function of wavelength-normalized height above a conductive object;

FIG. 5A is an exploded perspective view of the component layers of an RFID transponder, in accordance with an embodiment of the invention;

FIG. 5B is an exploded perspective view of the component layers of an alternative RFID transponder, in accordance with an embodiment of the invention;

FIG. 6A is a perspective view of an RFID transponder attached to a surface of an object having holes in its surface, in accordance with an embodiment of the invention;

FIG. 6B is a perspective view of an RFID transponder attached to a surface of a corrugated object, in accordance with another embodiment of the invention;

FIG. 7A is a Smith Chart illustrating the impedance of a multi folded dipole antenna, in accordance with an embodiment of the invention; and

FIG. 7B is a line chart illustrating the impedance of a multi folded dipole antenna, in accordance with an embodiment of the invention.

### DESCRIPTION OF SPECIFIC EMBODIMENTS OF THE INVENTION

The present invention, in some embodiments thereof, relates to tracking of objects, and more particularly, but not exclusively, to transponders useful in some radio frequency identification applications.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

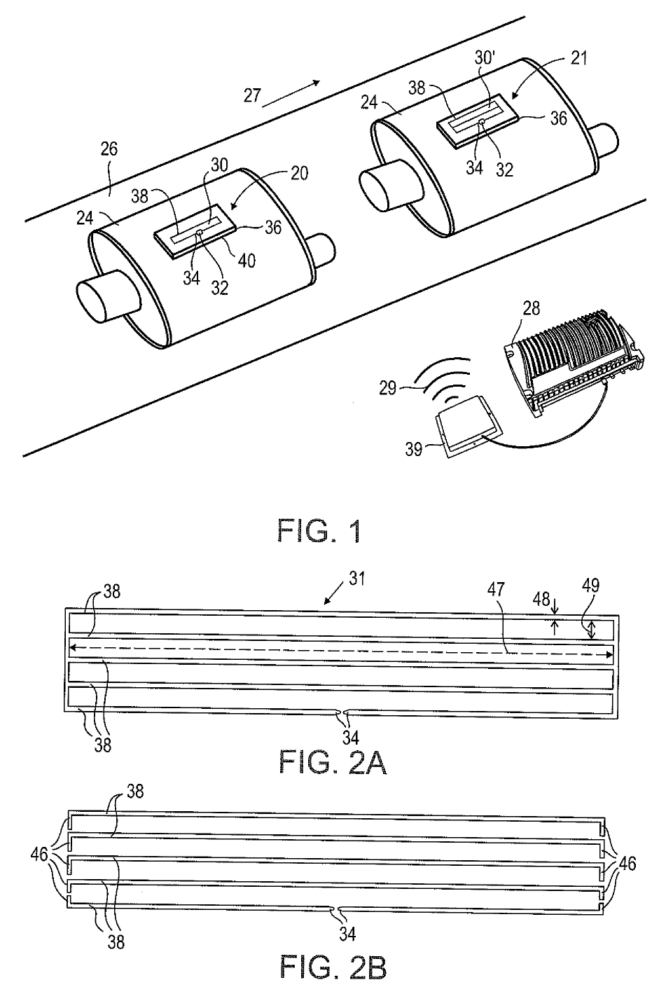

Referring now to the drawings, FIG. 1 illustrates a radio frequency identification (RFID) system showing two RFID transponders 20, 21 mounted on objects, in accordance with an embodiment of the invention.

In FIG. 1 RFID transponders 20, 21 are shown in the context of a sample RFID application. Two samples of an object 24 representing a larger number of objects are shown moving on a conveyor belt 26 in a direction indicated by arrow 27. Object 24 could be any object that is desired to be tracked, such as finished items in a distribution warehouse, or unfinished items in the course of production. In order to be tracked, each object 24 is provided with an attached transponder. For illustration purposes the size and thickness of transponders 20, 21 are enlarged relative to object 24. A reader or interrogator 28 transmits, over antenna 39, a radio frequency (RF) signal 29 which is received, demodulated, and processed by each transponder. One or more of the transponders sends a signal back to reader 28 in response, which then processes the information in some fashion, either by itself or through a separate external processor.

RFID transponder in accordance with an embodiment of the invention is typically used in radio frequency identification applications that operate in the 850-960 MHz portion of the ultra high frequency (UHF) band. In this band the corresponding wavelength range is approximately 350 mm (at 850 MHz) to about 310 mm (at 960 MHz). Some popular UHF bands used for commercial RFID applications are ISM 902-928 MHz in the U.S. and 868 MHz in Europe. It may be appreciated that the RFID transponder, in accordance with some embodiments of the invention, can also be used in other parts of the UHF band.

Object 24 is shown in FIG. 1 as an automobile muffler for illustration purposes, since it is well known that mufflers are made of metal and are therefore conductive. Some other to examples of conductive object 24 are: cast metal components on a production line, containers made of metal or having a metal surface, and relatively thin-walled non-conductive containers that contain a conductive liquid.

As will be discussed in greater detail below, RFID transponders according to various aspects of the invention are particularly suitable for use in RFID applications that track conductive objects, such as objects made of metal.

Two transponder embodiments are shown in FIG. 1, a first embodiment 20 and a second embodiment 21. Each embodiment comprises a multi folded dipole antenna 30 and 30′, respectively, an electronic circuit or ASIC chip 32, an antenna input port 34 to which the transponder is ported, and a separator 36. In first embodiment 20 multi folded dipole 30 comprises two dipoles 38, while in second embodiment 21 multi folded dipole 30′ comprises three dipoles 38. An additional element, a conductive ground plane 40 located on a bottom surface of separator 36, is included in first embodiment 20 but is not present in second embodiment 21. As described below, the number of dipoles 38 can vary and the antenna can be provided with a ground plane or not, in different embodiments.

The transponders as shown are passive transponders, having no battery or other local energy source, in accordance with an embodiment of the invention. The transponders can also be of the active or battery assisted (also called “semi-active”) type, which includes a battery, in accordance with other embodiments of the invention. In FIG. 1, both first and second transponder embodiments 20 and 21 are represented as passive transponders, and accordingly do not include a battery.

It should be understood that various transponders according to the invention can be passive or active, can be battery powered or not, can have various numbers of antennas or any of the variations described below and can have two or three of any greater number of dipoles and can have any combination of these features. The examples are presented in particular configurations for clarity of presentation and are not limiting.

A more detailed view of another embodiment of multi folded dipole antenna 31 is shown in FIG. 2A. In this embodiment the antenna has five dipoles 38. The first or lowest dipole 38 is split into two parts to accommodate antenna input port 34, while the other four dipoles 38 are continuous. It may be seen that input port 34 directly feeds one of dipoles 38, in this case the first dipole. It may also be seen that dipoles 38 are connected. More particularly, each dipole 38 is connected to at least one of the other dipoles 38 in antenna 31. In FIG. 2A dipoles 38 are connected at their outer ends, but it may be appreciated that other types of connections between dipoles are comprehended by the present invention. One such connection is shown below.

For convenience, the multiple dipoles 38 of antenna 31 may optionally be referred to as multiple “folds”. FIG. 2B is a representation, for illustration purposes, of multi folded dipole 31 of FIG. 2A in which the five component dipoles 38 are shown separated from one other. As indicated, a fold can be viewed as a dipole 38 with a folded end 46 at each of its two outer ends. A folded end is an extension of the dipole at an outer end, at a right angle to the dipole. Accordingly, the embodiment of multi folded dipole 30 of FIG. 2A, having five dipoles 38 connected by folded ends 46, may be said to have five folds and may optionally be referred to as a “five folded dipole”. Herein the term “folded antenna” is used even when there are no folds at the connection.

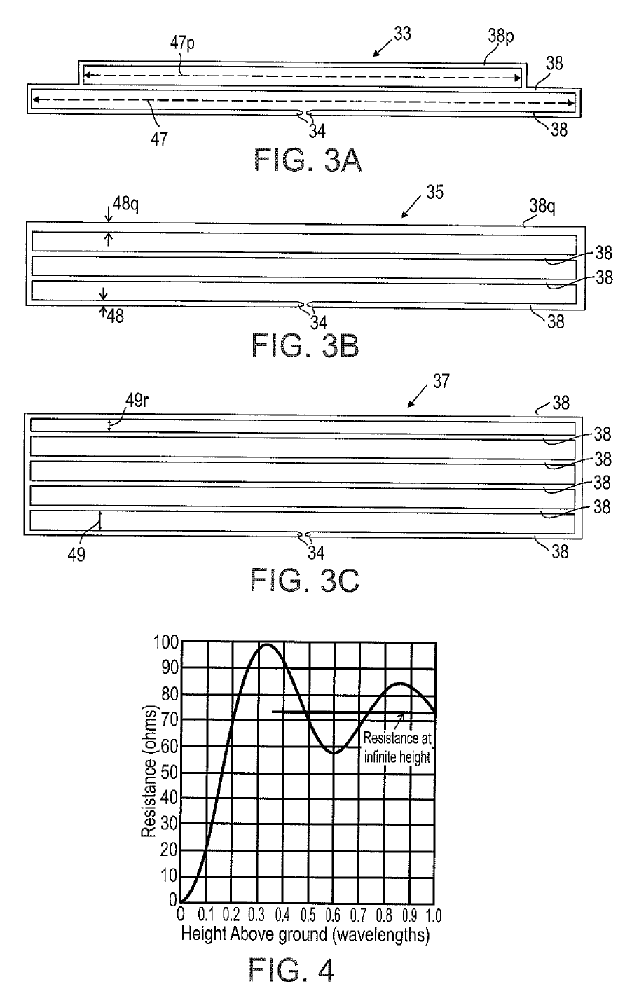

In FIGS. 3A-3C other embodiments of multi folded dipole antennas having different numbers of folds and other variations are shown. FIG. 3A shows a three folded dipole 33, having three dipoles 38. Similarly, FIG. 3B shows a four folded dipole antenna 35 having four dipoles 38, and FIG. 3C shows a six folded dipole 37 having six dipoles 38. It may be appreciated that multi folded dipole antennas according to various embodiments of the invention can have any greater number of folds than those shown in the embodiments of FIGS. 2 and 3, for example, embodiments having seven, eight, nine, or ten folds are possible.

As indicated in FIG. 2A, each of the dipoles 38 or corresponding folds in multi folded dipole 31 has a length 47, a width 48, and a dipole or fold spacing 49 defining a distance to an adjacent dipole 38 or fold. Length 47 is generally close in length to a half-wavelength of the operating frequency. For RFID transponders operating at 850-960 MHz UHF, dipole length 47 is accordingly within half of the full wavelength range of approximately 350 mm to 310 mm, or about 175 mm to 155 mm. Optionally, dipole length 47 can be adjusted to a value that is greater or lesser than a half-wavelength of the operating frequency, to aid in matching the antenna to the ASIC. Width 48 and dipole spacing 49 can each be set to values appropriate for the tag circuit. For example, for RFID tags operating at 915 MHz having a length 47 equal to the half-wavelength value of 164 mm, width 48 is typically in the range of about 1-5 mm and dipole spacing 49 is typically in the range of about 5-25 mm.

Generally, all dipoles 38 or folds have a same or uniform length 47, a same width 48, and a same spacing 49 or separation distance from an adjacent dipole. Optionally, any of these dimensions in any one or more of dipoles 38 could differ from the corresponding dimension of any one of the other dipoles 38. FIGS. 3A-3C show some examples of these non-uniform embodiments. FIG. 3A shows an embodiment of a three folded dipole antenna 33 in which the bottom two dipoles 38 have a common length 47, and the third dipole, designated as dipole 38p, has a shorter length 47p. It may also be appreciated that in antenna 33 dipole 38p is connected at its outer ends to an interior part of adjacent dipole 38. FIG. 3B shows an embodiment of a four folded dipole antenna 35 in which the first three dipoles 38 have a common width 48 and the top dipole, designated as dipole 38q, has a larger width 48q. Similarly, FIG. 3C shows a six folded dipole antenna 37 in which dipole spacing 49 between bottom five dipoles 38 is wider than spacing 49r between top two dipoles 38. Changes in and combination of changes in these parameters can be made to adjust the impedance and bandwidth of the antenna.

Dipoles 38 in multi folded antennas according to various embodiments of the invention are generally parallel to one another, as shown in FIGS. 2 and 3, but can also be oriented in a non-parallel manner. Non-parallel dipoles may be used to increase the antenna bandwidth. Separator 36 is uniform in thickness, so that each portion of antenna 30 is a common distance from the ground plane (either conductive ground plane 40 for first embodiment 20 or the surface of conductive object 24 for second embodiment 21). Accordingly, since dipoles 38 lie on the surface of separator 36, dipoles 38 may also be viewed as having a planar structure. Generally dipoles 38 form a flat, two-dimensional plane on the surface of separator 36. However it may be appreciated that the plane formed by dipoles 38 does not have to be flat in order for the antenna to be planar. For example, separator 36 and the antenna may bend around the edge of object 24, so that dipoles 38 form a structure having a curved planar surface.

Generally, as shown in the embodiments of FIGS. 2A, 3B, and 3C, the plane formed by dipoles 38 is a rectangle, having four internal angles that are congruent right angles. It may be appreciated that other, non-rectangular and non-quadrilateral embodiments are comprehended by the invention, such as the embodiment shown in FIG. 3A. In some embodiments dipoles 38 may not be aligned evenly, and accordingly form a plane that is not a rectangle. Furthermore, the dipoles may be curved slightly so that they are connected at their ends without folding.

A standard RFID transponder such as that currently in use in various conventional applications is generally about 0.1-0.2 mm thick. Accordingly, the antenna in the standard transponder is generally about 0.1 to 0.2 mm from the surface of the object being tracked. When operating in the UHF band of 850-960 MHz and measured in wavelengths, it may be determined that the antenna is approximately 0.0003 to 0.0006 wavelengths from the surface of the object being tracked. It may be appreciated that these distances are very small, and much less than 5% of the wavelength. Accordingly, if the surface of the object being tracked is conductive, it may be further appreciated that the antenna of the standard RFID transponder will experience a significant drop in impedance due to the antenna's close proximity to a conductive surface.

The nature of the impedance drop may be seen in FIG. 4. FIG. 4 is a graph of the radiation resistance of a (non-folded) quarter wave antenna, as a function of wavelength-normalized height above a conductive object. As indicated, beyond about a half-wavelength the resistance oscillates about and eventually settles at about 73 ohms, the characteristic impedance of a half-wavelength dipole in free space. The radiation resistance is close to 100 ohms when the dipole is 0.35 wavelengths above the ground, and then drops rapidly as the antenna is moved closer, dropping to about 5 ohms at a distance of 0.05 wavelengths above the ground. At a distance of 0.0003 or 0.0006 wavelength radiation resistance is close to zero.

Accordingly, it may be appreciated that when a half wavelength antenna is placed on a conductive object 24, the input impedance of the antenna gets driven to a very low value. Since the impedance of the ASIC chip is generally in the range of 5-20 ohms at the UHF frequency band 850-960 MHz, this makes impedance matching between the antenna and ASIC Chip difficult to achieve. For this reason, for a practical transponder thickness, a transponder utilizing a half wavelength antenna is not usable for the application of tracking conductive objects.

RFID transponders according to some embodiments of the present invention utilize an antenna having much higher impedance than a half wavelength antenna. This occurs because each additional dipole or fold in the multi folded dipole of the present invention increases the impedance of the antenna. The impedance of a particular embodiment of the multi folded dipole is about 73 ohms times the square of the folding ratio. Accordingly, a five folded dipole such as that shown in FIG. 2A, in free space, has an impedance (real part) of approximately (73×5²) or 1825 ohms. Similarly, the impedances of three, four, and six folded dipoles in free space are approximately (73×3²) or 657 ohms, (73×4²) or 1168 ohms, and (73×6²) or 2628 ohms, respectively.

Accordingly, it may be appreciated that insertion of multi folded dipole of the present invention in place of a simple dipole antenna in transponders 21, 22 raises antenna impedance substantially so as to compensate, at least in part, for the drop in impedance caused by proximity to conductive object 24. Multi folded dipole antennas accordingly can be sized and shaped to raise antenna impedance to approximately the impedance of ASIC chip 32, at the frequency of interest, enabling impedance matching to occur between the antenna and the chip, even while the antenna is in close proximity to conductive body 24.

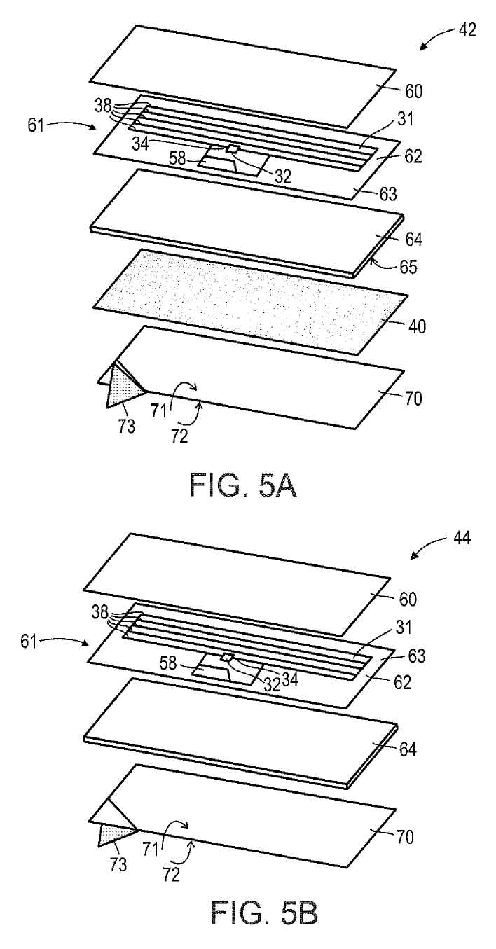

FIGS. 5A and 5B are exploded perspective views of two embodiments of an RFID label comprising an REID transponder, according to some embodiments of the invention. For clarity, the figures display an exploded view showing the component layers of the label. In particular, FIG. 5A illustrates first embodiment 42 and FIG. 5B illustrates second embodiment 44 of RFID labels in accordance with embodiments of the invention. The example transponders shown in FIGS. 5A and 5B are of the active or battery-assisted type, but have a substrate construction similar to that of transponders 20 and 21 of FIG. 1.

With reference to the transponder of FIG. 5A, the top of the label is optionally covered by a protective layer 60. This layer is generally made of an insulating material such as polyester, and functions to protect the interior of the transponder from dust, moisture, and other disturbances that may arise from the ambient environment or human contact.

The next layer, inlay 61, comprises a substrate 62, multi folded dipole antenna 31, and electronic circuit or ASIC chip 32. Substrate 62 is a dielectric insulating material, and is generally solid, dense, and sealed to provide adequate protection for the elements on its surface. The dielectric constant of substrate 62 is relatively high and generally in the range of about 4 to 5. Some examples of the types of materials from which substrate 62 can be made include polymer films such as polyester, or non-polymer materials such as paper. Substrate 62 can be any thickness, but generally a good combination of strength, flexibility, and minimal effect on dipole length is achieved with a thickness in the range of 0.05 to 0.10 mm (50-100 μm).

Multi folded dipole antenna 31 and electronic circuit or ASIC chip 32 are mounted on the surface of substrate 62. The lowermost dipole is split to form input port 34. Since the transponder in this case is active or battery-assisted, transponder 42 further includes a battery 58. One terminal of battery 58 is electrically connected to an input terminal of ASIC chip 32 (one terminal of input port 34), and another terminal of battery 58 is electrically connected to a second input terminal of ASIC chip 32. ASIC chip 32 generally has another input terminal which is connected to the other side of the battery. Applicants have found that providing a quarter wave matching section as described in U.S. patent application Ser. No. 12/424,749 filed on Apr. 16, 2009, between the battery and the ASIC generally improves performance.

Multi folded dipole 31 may be formed by deposition on substrate 62 or by other means known in the art. As noted, in first embodiment 42 multi folded dipole 31 comprises at least two folds, or two connected dipoles 38. Further, as may be seen in FIG. 5A, the at least two connected dipoles 38 form a planar structure that lies on a first or top surface 63 of substrate 62.

Antenna input port 34 indirectly feeds all the dipoles 38 of antenna 30, and is connected to electronic circuit 32. It may be appreciated that electronic circuit 32 comprises any transponder or electronic circuit that operates to produce the response signal from the RFID transponder when the circuit receives RF signal 29 at a given frequency from multi folded dipole antenna 31. Accordingly, electronic circuit 32 may be a circuit composed of individual electronic components as well as other types of integrated circuits, in addition to application specific integrated circuits (ASICs). Some examples of ASIC 32 that may be used in an RFID transponder according to some embodiments of the invention are UHF Passive ASIC Model Monza IPJ-W1002, made by Impinj (USA), and UHF Battery Assisted ASIC model EM 4324 made by EM Microelectronics (Switzerland).

The next layer of the transponder, lying underneath the inlay is spacer 64. This layer functions as a spacer to increase the distance or spacing between the multi folded antenna and the underlying conductive surface. As discussed further below, the underlying conductive surface may be conductive ground plane 40 or the surface of conductive object 24. Spacer 64 can be any desired thickness, and is generally in the range of 1 to 3 mm.

The material used for spacer 64 can be any solid dielectric. Low-density foam (density generally less than 0.15) is a good material for use as it is inexpensive and flexible. Another advantage of this material is that it has a low dielectric constant, generally less than about 1.25, and accordingly has negligible effect on antenna length. It may be appreciated that a solid, dense type of dielectric such as that used for substrate 62 is generally not desirable for use in spacer 64, as in addition to being rigid and costly, it would act to reduce antenna resonant frequency and length, leading to lower antenna gain and efficiency. However, under some conditions it may be used. Accordingly, spacer 64 generally comprises a dielectric that has a lower dielectric constant than the dielectric used for substrate 62.

The next layer in embodiment 42 is conductive ground plane 40. As can be seen in the figure, conductive ground plane 40 lies on or is in contact with a second or bottom surface 65 of spacer 64. Separator 36 in this embodiment is the distance or thickness between top surface 63 of substrate 62 and bottom surface 65 of spacer 64. Conductive ground plane 40 generally matches the length and width dimensions of spacer 64, but optionally covers only a portion of the surface area of spacer 64. Preferably, it has an extent at least as large as that of the antenna.

Conductive ground plane 40 is a conductive material, generally metal, such as copper or aluminum film. This layer can have any thickness, but is generally only a few microns thick, and is accordingly thin and flexible. An adhesive (not shown in the figure) is optionally applied to the bottom surface of conductive ground plane 40. The adhesive can be either conductive or non-conductive. Non-conductive adhesive is more commonly used since conductive adhesive is generally costly and tends to not be a strong conductor.

Conductive ground plane 40 assists in reducing the effect of two problems that often arise when a transponder is attached to the surface of a metal or other conductive object. In the first case, if the attachment is not sufficiently tight and smooth it is common for air bubbles to form between the transponder and the metal surface. Air bubbles in this location are likely to affect the impedance of the antenna, even when the bubbles are relatively small in size such as 0.2 mm. The presence of conductive ground plane 40 as part of transponder 42 reduces or eliminates this problem, since conductive ground plane 40 is integral to the transponder and can be manufactured to a sufficiently tight tolerance that ensures the absence of air bubbles between antenna 30 and conductive ground plane 40. It may be further appreciated that where the transponder includes conductive ground plane 40, any air bubbles that may form on the other side of conductive ground plane 40, between the bottom of the transponder and the conductive object, will have negligible or no effect on the impedance of the antenna.

The second problem is that antenna operation will be affected if the antenna is not straight or parallel to the conductive surface, which can happen if the label is not attached sufficiently tightly to the surface of the object. In particular, all points of the antenna should be equidistant from the conductive surface.

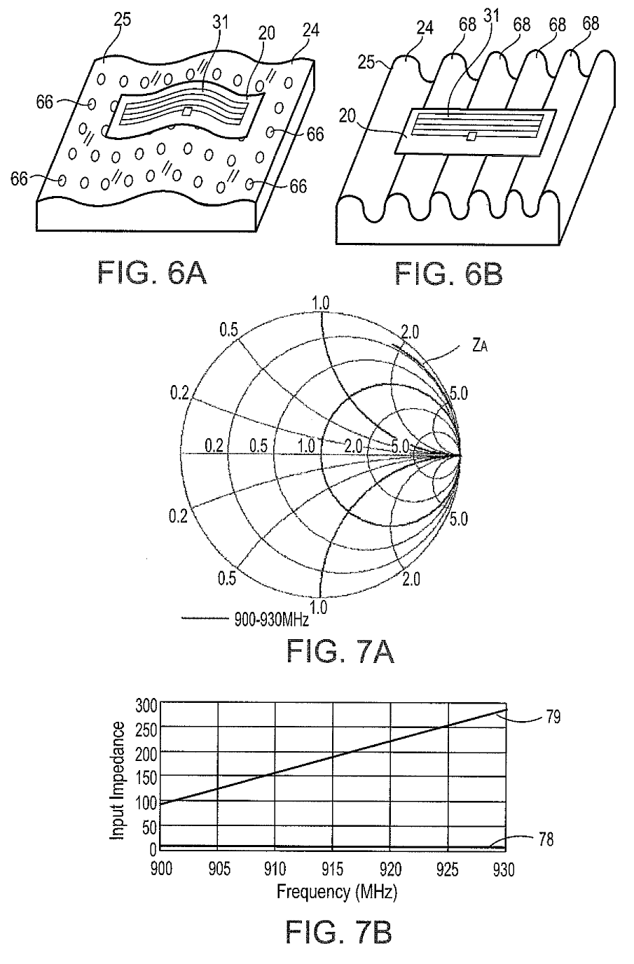

In some cases such as when a surface 25 of conductive object 24 is uneven or has holes, even a tight attachment will not help. FIG. 6A shows such an example, in which passive transponder 20 is attached to conductive object 24 whose surface 25 is uneven and contains holes 66. It may be appreciated that points on multi folded antenna 31 that lie above holes 66 will operate differently than points that lie above the conductive part of surface 25.

In other cases, such as when surface 25 is highly uneven or corrugated, it may not be possible to attach the RFID label evenly to the surface. An example of this is shown in FIG. 6B, where transponder 20 is only able to make contact with corrugated surface 25 at raised points 68. Again it may be appreciated that different points on the antenna will react differently, depending on their distance from conductive surface 25.

In the above cases the problem of uneven antenna to ground plane distance can be resolved by employing first embodiment 20 of the transponder, which includes conductive ground plane 40. The presence of a second ground plane as part of transponder 20 ensures that the distance between the antenna and an adjacent conductive surface is even for all points of the antenna. For the purposes of this document, this is considered a planar antenna.

The bottom layer of embodiment 42, in contact with the lower surface of conductive ground plane 40, is generally an adhesive layer 70 such as a double coated tape with a liner 73 on one side. A top surface 71 of adhesive layer 70 attaches to the bottom of conductive ground plane 40, and a bottom surface 72 attaches to object 24 being tracked. Liner 73 protects bottom surface 72, and is peeled off by the user at the time of application of the RFID label to the object.

FIG. 5B shows second transponder embodiment 44. As indicated in the figure, this embodiment comprises the same layers as first embodiment 42 shown in FIG. 5A but does not include conductive ground plane 40. As noted, in this embodiment multi folded dipole 31 comprises five folds, or five connected dipoles 38. Further, as may be seen in FIG. 5B, the five connected dipoles 38 form a planar structure that lies on top surface 63 of substrate 62.

Separator 36 defines the separation or distance between multi folded antenna 31 and the nearest ground plane whose proximity would affect the impedance of antenna 31. In this embodiment, separator 36 accordingly comprises the components separating the antenna from conductive object 24, specifically substrate 62, spacer 64, and adhesive layer 70. Accordingly, the separation or distance from antenna 31 to conductive object 24 is the distance between first surface 63 on the top of substrate 62 and surface 72 on the bottom of adhesive layer 70. It may be appreciated that since substrate 62 is relatively small and varies only slightly (generally between 0.05 and 0.1 mm), the size of separator 36 varies primarily with the size of spacer 64.

All of the layers of RFID label 42 and 44 are optionally flexible, so the label itself is flexible and can be easily applied to the surface of conductive object 24. The overall thickness of the transponder is generally in the range of about 2.5 to 3 mm, which again differs from the approximate 1 mm thickness of a conventional active or battery-assisted tag primarily by the thickness of foam spacer 64. Accordingly, it may be appreciated that RFID transponders, in accordance with an embodiment of the invention, have a thickness that is relatively close to that of a conventional active or battery-assisted tag, and represent an improvement over some tags of the prior art which require much greater thickness to perform effectively when used to track conductive objects.

As noted, for optimum efficiency and maximum power transfer the antenna input impedance should be substantially the complex conjugate of chip input impedance at the frequency of operation of the transponder. In practice, the reflection coefficient between matched components should be minimal, or as low as possible. In RFID transponders of an embodiment of the present invention, the multi folded dipole antenna may be sized and shaped to form an impedance match with ASIC chip 32 with a reflection coefficient of about no more than 0.2 to 0.3 over the width of the operating band. For example, the antenna may have a reflection coefficient with respect to the ASIC of about 0.3 over the band of 902-928 MHz, with a lower reflection coefficient of about 0.15 at the 915 MHz center frequency of the band.

As noted, for proper matching both the real and imaginary parts of the impedance should be matched. Since the real part of the impedance of ASIC chip 32 is about 10 ohms, it is desirable that the real part of the antenna impedance also be 10 ohms when the antenna is in operation, i.e., when it attached to conductive object 24.

In REID transponders, in accordance with an embodiment of the invention, a multi folded antenna is used to raise the real part of antenna impedance to a relatively high value in free space. Accordingly, when the transponder is in operation, attached in close proximity to conductive object 24, the antenna impedance will still drop but to a correspondingly high value of about 10 ohms rather than to a value close to zero. Accordingly, the increased impedance in free space of multi folded antennas compensates for the large drop in impedance that occurs when the antennas are used in close proximity to conductive object 24.

The accuracy or effectiveness of the compensation generally depends on two factors. The first factor is the impedance of the antenna in free space, which as noted is a function of the number of folds applied to the multi folded antenna. The second factor is the proximity or separation distance between the antenna and the conductive surface, i.e. the size of separator 36, since the closer the proximity, the greater will be the degree or scale of impedance drop. As noted the size of separator 36 is primarily governed by the thickness of foam spacer 64, which can be varied relatively easily during manufacture of the RFID transponder.

There is generally an inverse relationship between the number of folds in a multi folded antenna and the size of separator 36. It may be appreciated that as separator 36 thickness decreases, the number of folds in the multi folded dipole will generally need to increase, in order to raise antenna input impedance sufficiently to counteract the greater drop imposed by conductive object 24. Conversely, as separator 36 increases in thickness the impedance drop will be less, and the multi folded dipole will generally need fewer folds.

Further, separator 36 may be sized and shaped so that its thickness is less than five percent of the wavelength at the given frequency. Optionally, separator 36 may be sized and shaped so its thickness is less than two percent, or further, less than one percent, of the wavelength at the given frequency. For the UHF frequency range of 850 MHz to 960 MHz, as noted wavelength varies between 350 mm to 310 mm. Accordingly, separator 36 may optionally be sized and shaped to have a thickness of 17.5 mm, 7 mm, or 3.5 mm, for a transponder operating at 850 MHz, or a thickness of 15.5 mm, 6.2 mm, or 3.1 mm, for a transponder operating at 960 MHz.

More particularly, adequate impedance matching results have been obtained for an RFID transponder operating in the 902-928 MHz band, according to some embodiments of the invention, in which the multi folded antenna has between two or three folds and about six folds, and with separator 36 thickness in the range of 1.5 to 2 mm. At this size of separator 36 the overall thickness of the transponder is about 2-3 mm, which is less than 1% of the wavelength for this frequency band (330 mm at 915 MHz). It may be appreciated that, unlike some prior art devices which require a relatively thick spacer to avoid the problem caused by proximity to a conductive surface, the transponder according to an embodiment of the invention can be relatively thin due to the increased impedance of the multi folded antenna.

It may be appreciated that first transponder embodiment 20 comprises a “universal” RFID tag that works with both conductive and non-conductive objects 24. The antenna characteristics of the universal tag are independent of the object on which the transponder that contains the antenna is mounted.

As noted, the ASIC chip impedance is generally about 10 −j200 ohms when operating in the 850-960 MHz band. In order to match, or cancel out, the imaginary part of the chip impedance of j200 ohms, the antenna impedance should have an imaginary part of about +j200 ohms. This can be achieved by varying the length 47 of one or more dipoles 38 in multi folded antenna 30. More particularly, the length of each dipole is substantially one half-wavelength at the operating frequency. Optionally the length of each dipole can be adjusted to a value greater or lesser than one half-wavelength to obtain a desired impedance value.

For example, when operating in the 902-928 MHz band, the central frequency of 915 MHz has a half-wavelength of about 164 mm (or 6.46 inches). In practice, due to the effect of the substrate dielectric, resonance occurs at a length of about 155 mm. Dipoles 38 of the multi folded dipole antenna need to vary from the half-wavelength or resonance length to some degree, since at resonance the imaginary part of the impedance is zero. In the case of 915 MHz, in some embodiments, it has been found that the multi folded dipole antenna will have an imaginary impedance of about +j200 ohms when dipoles 38 are approximately 140 mm in length. For this reason, it may be appreciated that the multi folded dipole of transponder 20, 21 generally operates off resonance, and is designed to match the ASIC chip impedance off resonance.

The multi folded dipole antenna can also be used in applications that do not involve radio frequency identification (RFID), and in which a multi-folded antenna is not part of an RFID transponder or label.

Various embodiments and aspects of the present invention as delineated hereinabove and as claimed in the claims section below find experimental support in the following examples.

### Example

Reference is now made to the following example, which together with the above descriptions illustrates some embodiments of the invention in a non limiting fashion.

In an embodiment of the invention, an RFID transponder operating in the 902-930 MHz UHF band having a substrate thickness of 75 μm with a foam spacer of 2 mm from a metallic ground plane was conjugate matched to an ASIC Chip having a chip impedance of 10 −j200 ohms at 915 MHz by using a five folded dipole antenna. The length, width, and spacing of the five folds (with reference to FIG. 2A) was 140 mm, 1 mm, and 5 mm respectively.

For this example, a Smith Chart showing antenna impedance Z_{A} over the 900-930 MHz band is shown in FIG. 7A, and a line chart showing the real part of antenna impedance 78 and the imaginary part of antenna impedance 79 is shown in FIG. 7B.

As used herein the term “about” refers to ±10%.

The terms “comprises”, “comprising”, “includes”, “including”, “having” and their conjugates mean “including but not limited to”.

As used herein, the singular form “a”, “an” and “the” include plural references unless the context clearly dictates otherwise.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Although the above embodiments show direct (conductive) coupling between the ASIC and the multi-fold antenna, the ASIC can be coupled to the antenna by electromagnetic (e.g., capacitive or inductive) coupling, as known in the art and described in U.S. patent application Ser. No. 12/424,749 filed on Apr. 16, 2009.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A radio frequency identification (RFID) transponder comprising:
an antenna comprising at least two connected dipoles, and having an input port feeding only one of the dipoles;
a conductive ground plane separated by a predetermined distance from the antenna by a dielectric; and
a transponder electrically connected to the input port and operative to produce a response signal when the transponder receives a signal at a given frequency from the antenna.

2. A radio frequency identification (RFID) transponder according to claim 1, wherein the at least two dipoles comprise at least three dipoles.

3. A radio frequency identification (RFID) transponder according to claim 1, wherein at the given frequency the real part of the input impedance of the antenna in free space in the absence of the conductive ground plane is at least 100 ohms.

4. A radio frequency identification (RFID) transponder according to claim 3, wherein at the given frequency the real part of the input impedance of the antenna in free space in the absence of the conductive ground plane is at least 200 ohms.

5. A radio frequency identification (RFID) transponder according to claim 3, wherein at the given frequency the imaginary part of the input impedance of the antenna in free space in the absence of the conductive ground plane is greater than +j100 ohms.

6. A radio frequency identification (RFID) transponder comprising:
an antenna comprising at least three connected dipoles, and having an input port feeding only one of the dipoles, and
a transponder electrically connected to the input port and operative to produce a response signal when the transponder receives a signal at a given frequency from the antenna.

7. A radio frequency identification (RFID) transponder according to claim 6, wherein at the given frequency the real part of the input impedance of the antenna in free space is at least 100 ohms.

8. A radio frequency identification (RFID) transponder according to claim 7, wherein at the given frequency the real part of the input impedance of the antenna in free space is at least 200 ohms.

9. A radio frequency identification (RFID) transponder according to claim 7, wherein at the given frequency the imaginary part of the input impedance of the antenna in free space is greater than +j100 ohms.

10. A radio frequency identification (RFID) transponder according to claim 1, wherein the dipoles are parallel.

11. A radio frequency identification (RFID) transponder according to claim 10, wherein the structure formed by the dipoles is rectangular.

12. A radio frequency identification (RFID) transponder according to claim 11, wherein the antenna is sized and shaped to form an impedance match with the transponder with a reflection coefficient of less than or equal to 0.25 at the given frequency.

13. A radio frequency identification (RFID) transponder according to claim 6, wherein the antenna is mounted on a dielectric structure having a given thickness, less than five percent of the free space wavelength at the given frequency.

14. A radio frequency identification (RFID) transponder according to claim 13, wherein the thickness is less than two percent of the free space wavelength at the given frequency.

15. A radio frequency identification (RFID) transponder according to claim 14, wherein the thickness is less than one percent of the free space wavelength at the given frequency.

16. A radio frequency identification (RFID) transponder according to claim 1, wherein each of the dipoles has a same length, a same width, and a same separation distance from an adjacent dipole.

17. A radio frequency identification (REID) transponder according to claim 16, wherein one of the dipoles has at least one of a length, a width, and a separation distance from an adjacent dipole that is different from the corresponding length, width, or separation distance of at least one other dipole.

18. A radio frequency identification (RFID) transponder according to claim 1, wherein a major portion of the dielectric is formed from a dielectric material having a first dielectric constant and a thickness in the range of 1 to 3 mm.

19. A radio frequency identification (RFID) transponder according to claim 18, wherein a the dielectric is formed of two layers and a thinner dielectric layer has a second dielectric constant higher than the first dielectric constant and a thickness in the range of 0.025 to 0.10 mm.

20. A method comprising attaching the transponder of claim 6 to a conductive surface.

21. A method comprising attaching the transponder of claim 1 to a conductive surface.

22. An antenna comprising:
a conductive ground plane,
at least two connected dipoles forming a structure substantially parallel to the conductive ground plane, and
an input port feeding only one of the dipoles.

23. An antenna according to claim 22, wherein at a given frequency the real part of the input impedance of the antenna in free space in the absence of the conductive ground plane is at least 100 ohms.

24. An antenna according to claim 23, wherein at the given frequency the real part of the input impedance of the antenna in free space in the absence of the conductive ground plane is at least 200 ohms.

25. An antenna according to claim 24, wherein at the given frequency the imaginary part of the input impedance of the antenna in free space in the absence of the conductive ground plane is greater than +j100 ohms.

26. An antenna according to claim 25, wherein the at least two dipoles are separated from the conductive ground plane by a dielectric material having a thickness is in the range of 1 to 3 mm.

27. An antenna according to claim 26, wherein the structure formed by the dipoles is rectangular.

28. An antenna comprising:
at least three connected dipoles, and
an input port that feeds the dipoles.
